(19) United States
(12) Patent Application Publication
(10) Pub. No.: US 2011/0234381 A1
(43) Pub. Date: Sep. 29, 2011

(54) RADIO FREQUENCY IDENTIFICATION DEVICE

(75) Inventor: Hee Bok KANG, Cheongju (KR)

(73) Assignee: Hynix Semiconductor Inc., Icheon (KR)

(21) Appl. No.: 12/827,942

(22) Filed: Jun. 30, 2010

(30) Foreign Application Priority Data
Mar. 26, 2010 (KR) 10-2010-0027489

(51) Int. Cl. H04Q 5/22

(52) U.S. Cl. 340/10.4

(57) ABSTRACT

A radio frequency identification (RFID) device performs a test on tag chips using a parallel test mode to reduce a test time and improve a test speed. The RFID device includes a plurality of tag chips each configured to perform a test in response to an externally applied test input signal and output a test output signal corresponding to a test result, and a test chip configured to perform a parallel test on the plurality of tag chips simultaneously in response to data, an address and a control signal applied from the outside through a pad in a test mode.

### CROSS-REFERENCE TO RELATED APPLICATION

The priority of Korean patent application No. 10-2010-0027489 filed on Mar. 26, 2010, the disclosure of which is hereby incorporated in its entirety by reference, is claimed.

### BACKGROUND OF THE INVENTION

Embodiments of the present invention relate to a radio frequency identification (RFID) device, and more specifically, to a technology for identifying an object by wirelessly transmitting and receiving a radio frequency (RF) signal to and from an external reader.

An RFID tag chip has been widely used to automatically identify objects using an RF signal. In order to automatically identify an object using the RFID tag chip, an RFID tag is attached to the object to be identified, and an RFID reader wirelessly communicates with the RFID tag of the object using a non-contact automatic identification scheme. The widespread use of these RFID technologies can overcome the shortcomings of a conventional automatic identification technology, such as a barcode and an optical character recognition technology.

In recent times, the RFID tag has been widely used in physical distribution management systems, user authentication systems, electronic money (e-money), transportation systems, and the like.

For example, the physical distribution management system generally performs the classification of goods or management of goods in stock using an integrated circuit (IC) recording data therein, instead of using a delivery note or tag. In another example, the user authentication system generally performs an entrance and exit management function using an IC card including personal information or the like.

A non-volatile ferroelectric memory may be used as a memory in an RFID tag. Generally, a non-volatile ferroelectric memory [e.g., a ferroelectric random access memory (FeRAM)], has a data processing speed similar to that of a dynamic random access memory (DRAM). The non-volatile ferroelectric memory also preserves data even when power is turned off. This has many developers conducting intensive research into FeRAM as a next generation memory device.

The FeRAM has a similar structure to that of DRAM but uses a ferroelectric capacitor as a storage element. A ferroelectric material has a high remnant polarization characteristic, such that data is not lost although an electric field is removed.

FIG. 1 is a block diagram illustrating a general RFID device. The RFID device generally includes an antenna unit 1, an analog unit 10, a digital unit 20, and a memory unit 30.

The antenna unit 1 receives an RF signal from an external RFID reader. The RF signal received through the antenna unit 1 is input to the analog unit 10 via antenna pads 11 and 12.

The analog unit 10 amplifies the input RF signal and generates a power-supply voltage VDD which can then be used as a driving voltage of an RFID tag. The analog unit 10 detects an operation command signal from the input RF signal, and outputs a command signal CMD to the digital unit 20. In addition, the analog unit 10 detects the output voltage VDD and outputs a power-on reset signal POR (for controlling a reset operation) and a clock CLK to the digital unit 20.

The digital unit 20 receives the power-supply voltage VDD, the power-on reset signal POR, the clock CLK, and the command signal CMD from the analog unit 10, and outputs a response signal RP to the analog unit 10. The digital unit 20 outputs an address ADD, input/output data I/O, a control signal CTR, and the clock CLK to the memory unit 30.

The memory unit 30 reads, writes and stores data using a memory device.

In this case, the RFID device uses frequencies of various bands. In general, as a value of the frequency band is lowered, the RFID device has a lower recognition speed, operates at a shorter distance, and is less affected by the surrounding environment. In contrast, as the value of the frequency band is increased, the RFID device has a higher recognition speed, operates at a greater distance, and is considerably affected by the surrounding environment.

The most preferable method for testing if the RFID tag operates normally is as follows. An RF signal is applied through the antenna pads 11 and 12 of the individual RFID tag, and processed by the digital unit 20 in the RFID tag to generate the response signal RP. The response signal RP is modulated and transmitted to the RFID reader, which checks whether the received signal is a desired signal or not.

However, apply an RF signal individually to thousands of RFID tags per wafer to test the RFID tags is inefficient and high cost.

### BRIEF SUMMARY OF THE INVENTION

Various embodiments of the invention are directed to a technology of directly applying a measuring signal through a test pad at a wafer level without using an RF signal applied from an antenna to test the performance of an RFID tag chip.

Various embodiments of the invention are directed to a technology of testing each RFID tag chip using a parallel test mode to reduce a test time and improve a test speed.

According to an embodiment of the present invention, a RFID device comprises: a plurality of tag chips each configured to perform a test operation in response to a test input signal applied from an external node and output a test output signal corresponding to a result of the test operation; and a test chip configured to perform a parallel test on the plurality of tag chips in response to a control signal applied from an external node in a test mode.

According to an embodiment of the present invention, an RFID device comprises: an analog unit configured to output a command signal in response to a test input signal applied from the outside and output a test output signal corresponding to a response signal to the outside in a test mode; a digital unit configured to output the response signal to the analog unit and output operation control signals in response to the command signal; a memory unit configured to read out or write data in a cell array in response to an internal control signal; a test interface unit configured to generate the internal control signal in response to data and a control signal applied from the outside, perform a test operation on the memory unit, and output a result of the test operation to the outside; and a test control unit configured to control activation of the analog unit and the test interface unit in response to a test mode signal, a test clock and an address applied from the outside.

### BRIEF DESCRIPTION OF THE DRAWINGS

FIG. 1 is a block diagram illustrating a general RFID device.

FIG. 2 is a block diagram illustrating a RFID device according to an embodiment of the present invention.

FIG. 3 illustrates alignment of a test chip and tag chips on a wafer according to an embodiment of the present invention.

FIG. 4 illustrates the pad configuration of a test chip according to an embodiment of the present invention.

FIGS. 5 and 6 are a flowchart and a timing diagram illustrating a test activation operation for a digital unit in a tag chip.

FIGS. 7 and 8 are a flowchart and a timing diagram illustrating a test activation operation for a memory unit in the tag chip.

FIG. 9 is a diagram illustrating a test control unit in FIG. 2.

FIG. 10 is a circuit diagram illustrating a test mode selecting decoder in FIG. 9.

FIG. 11 is a circuit diagram illustrating an address decoder and a test activation decoder in FIG. 9.

FIGS. 12 to 15 are diagrams illustrating a parallel test method of the tag chips.

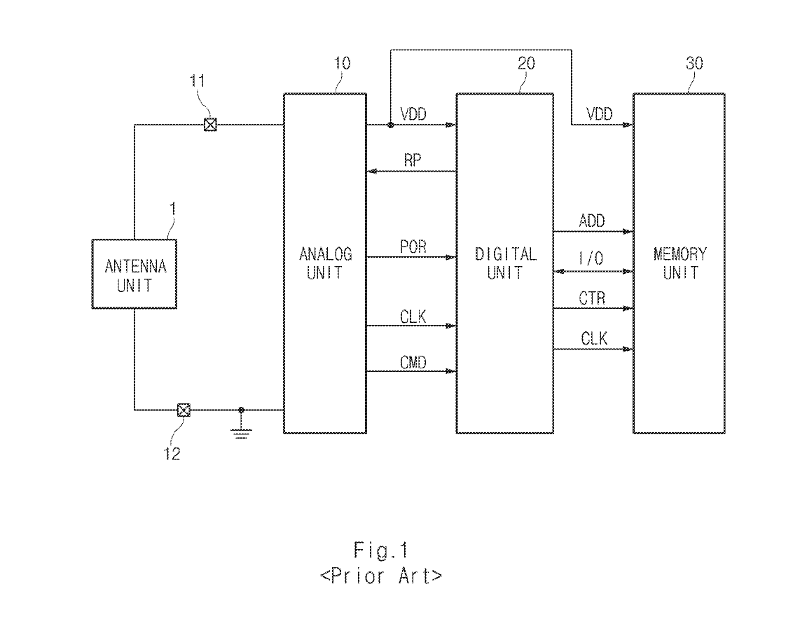

### DESCRIPTION OF EMBODIMENTS

Reference will now be made in detail to the embodiments of the present invention, examples of which are illustrated in the accompanying drawings. Wherever possible, the same reference numbers will be used throughout the drawings to refer to the same or like parts.

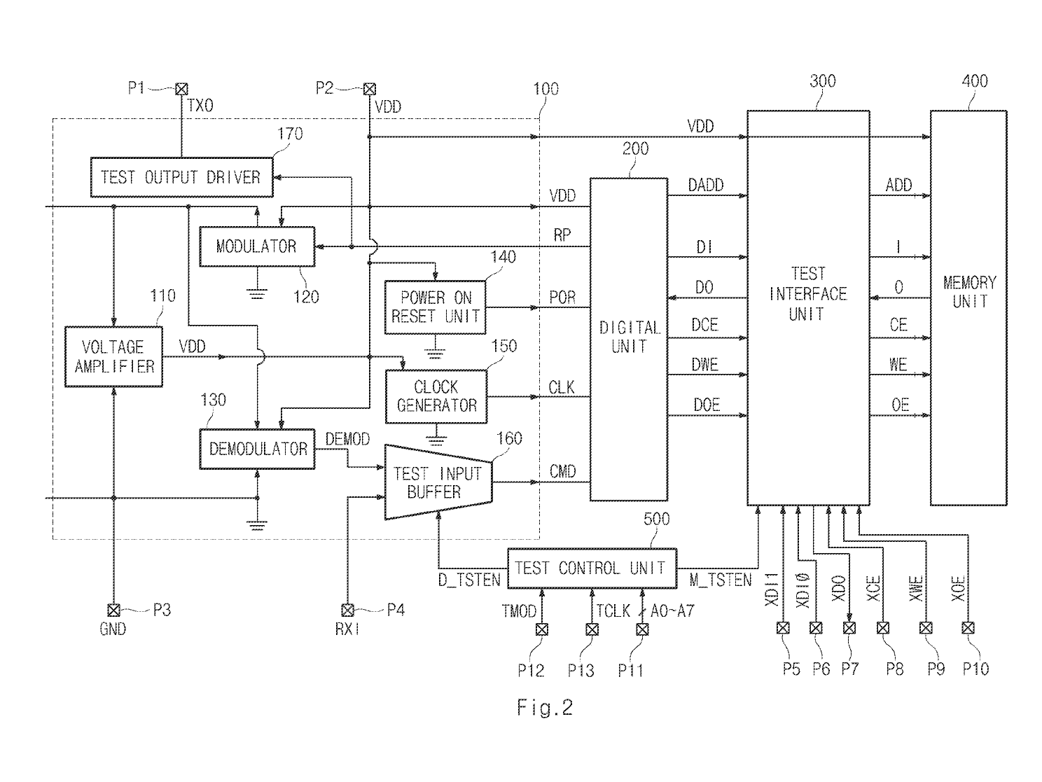

FIG. 2 is a block diagram illustrating an RFID device according to an embodiment of the present invention.

The RFID device receives a measuring signal directly through a parallel test pad at a wafer level, whereas the conventional RFID device receives an RF signal from the antenna 1, to test the performance of an RFID tag chip.

The RFID device includes an analog unit 100, a digital unit 200, a test interface unit 300, a memory unit 400 and a test control unit 500.

The analog unit 100 includes a voltage amplifier 110, a modulator 120, a demodulator 130, a power on reset unit 140, a clock generator 150, a test input buffer 160 and a test output driver 170.

The voltage amplifier 110 generates a driving voltage of the RFID device depending on a power voltage VDD applied from a power voltage applying pad P2.

The modulator 120 modulates a response signal RP input from the digital unit 200. The demodulator 130 generates an operation command signal DEMOD depending on an output voltage of the power voltage applying pad P2 and outputs the operation command signal DEMOD to the test input buffer 160.

The power on reset unit 140 senses the output voltage of the power voltage applying pad P2 and outputs a power on reset signal POR for controlling a reset operation to the digital unit 200. The clock generator 150 supplies a clock CLK for controlling an operation of the digital unit 200 to the digital unit 200 depending on the output voltage of the power voltage applying pad P2.

A voltage level of the power on reset signal POR rises with the power voltage while the power voltage changes from a low level to a high level. When the power voltage reaches a power voltage level VDD, the power on reset signal POR changes from the high level to the low level to reset the circuit in the RFID tag.

The test input buffer 160 outputs a command signal CMD to the digital unit 200 in response to a test input signal RXI input through a test signal input pad P4, the operation command signal DEMOD input from the demodulator 130 and a digital test signal D_TSTEN applied from the test control unit 500.

In accordance with this embodiment, the test input buffer 160 supplies the command signal CMD to the digital unit 200 in response to the operation command signal DEMOD applied from the demodulator 130 when the digital test signal D_TSTEN is inactivated in a normal mode.

On the other hand, the test input buffer 160 supplies the command signal CMD for testing the digital unit 200 to the digital unit 200 in response to the test input signal RXI applied from the test signal input pad P4 when the digital test signal D_TSTEN is activated in a test mode.

The test output driver 170 drives a test output signal TXO in response to the response signal RP input from the digital unit 200 to output a command processing result of the RFID device to the outside through a test signal output pad P1.

In the test mode for testing the performance of the RFID device, the voltage amplifier 110, the modulator 120, the demodulator 130, the power on reset unit 140, the clock generator 150, the test input buffer 160 and the test output driver 170 are driven by the power voltage VDD applied from the power voltage applying pad P2 and a ground voltage GND applied from a ground voltage applying pad P3.

That is, the power voltage applying pad P2 represents a pad for receiving the power voltage VDD when a plurality of RFID tags are tested on a wafer during activation of the RFID tags. The ground voltage applying pad P3 represents a pad for receiving the ground voltage GND when the plurality of RFID tags is tested on the wafer.

When the RFID tag receives an RF signal in communication with the RFID reader, the voltage amplifier 110 supplies the power voltage VDD. However, since a test is performed on the wafer in accordance with the embodiment of the present invention, the power voltage VDD and the ground voltage GND are supplied through the power voltage applying pad P2 and the ground voltage applying pad P3.

The digital unit 200 receives the power voltage VDD, the power on reset signal POR, the clock CLK and the command signal CMD from the analog unit 100 to analyze the command signal CMD and generate a control signal and processing signals. The digital unit 200 outputs the response signal RP corresponding to the control signal and the processing signals to the analog unit 100.

The digital unit 200 outputs an address DADD, input data DI, a chip enable signal DCE, a write enable signal DWE and an output enable signal DOE to the test interface unit 300. The digital unit 200 receives output data DO from the test interface unit 300.

The test interface unit 300 is activated in response to a memory test signal M_TSTEN applied from the test control unit 500. When the test interface unit 300 is activated, the memory unit 400 is tested in response to input data XDI0 and XDI1 and control signals XCE, XWE, and XOE, which are input from the outside of the RFID tag.

Of the above control signals, XCE represents a chip enable signal, XWE represents a write enable signal and XOE represents an output enable signal.

The test interface unit 300 generates an address ADD and control signals I, CE, WE and OE in response to the input data XDI1 and XDI0 input through pads P5 and P6, respectively, and the control signals XCE, XWE and XOE input through control signal input pads P8˜P10, respectively, so as to test the memory unit 400.

The test interface unit 300 receives a control result signal O and generates output data XDO through a data output pad P7 to the outside.

If the test interface unit 300 is activated, the test interface unit 300 tests the internal circuits (i.e., the analog unit 100, the digital unit 200 and the memory unit 400) which are included in the RFID tag, in response to the address DADD and the control signals DI, DCE, DWE and DOE from the digital unit 200.

The digital unit 200 for testing the whole operation of the RFID tag generates the address DADD and the control signals DI, DCE, DWE and DOE based on the command signal CMD generated in response to the test input signal RXI.

The test interface unit 300 generates the address ADD and the control signals I, CE, WE and OE in response to the address DADD and the control signals DI, DCE, DWE and DOE to test the whole operation of the RFID tag. The test interface unit 300 receives the control result signal O representing a test result from the memory unit 400 to generate the test result signal DO.

The digital unit 200 generates the response signal RP in response to the test result signal DO. The test output driver 170 drives the response signal RP to output the test output signal TXO through the test signal output pad P1.

The memory unit 400 includes a plurality of memory cells. Each memory cell writes data in a storage element and reads out the data stored in the storage element.

For the memory unit 400, a non-volatile ferroelectric memory may be used in the RFID tag. Generally, a non-volatile ferroelectric memory [e.g., a ferroelectric random access memory (FeRAM)], has a data processing speed similar to that of a dynamic random access memory (DRAM). Also, FeRAM has a structure similar to that of DRAM but with a high remnant polarization characteristic, such that data is not lost although an electric field is removed.

The test control unit 500 activates the RFID tag in the test mode. The test control unit 500 receives a test mode signal TMOD from a test input pad P12, a test clock TCLK from a test clock input pad P13 and addresses A0˜A7 from an address input pad P11.

The test control unit 500 outputs the digital test signal D_TSTEN (for controlling activation of the digital unit 200 in the RFID tag) to the test input buffer 160. The test control unit 500 also outputs the memory test signal M_TSTEN (for controlling activation of the memory unit 400) to the test interface unit 300.

When the digital test signal D_TSTEN is activated in the test mode, a test result of the digital unit 200 is outputted through the test signal output pad P1. When the memory test signal M_TSTEN is activated in the test mode, a test result of the memory unit 400 is outputted through the data output pad P7.

In the whole operation of the RFID device (i.e., when the digital unit 200 is tested) the test input signal RXI input through the test signal input pad P4 is transmitted to the digital unit 200, the test interface unit 300 and the memory unit 400, and the test result is output via the test interface unit 300, the digital unit 200 and the test output driver 170 to the test signal output pad P1. External text equipment measures the output of the test signal output pad P1 to test the whole operation of the RFID device.

When only the memory unit 400 of the RFID device is tested, the input data XDI1 and XDI0 input through the pads P5 and P6 are transmitted to the memory unit 400 through the test interface unit 300, and the test result is output to the data output pad P7 via the test interface unit 300. Then, the external test equipment measures the output of the data output pad P7 to test the operation of the memory unit 400.

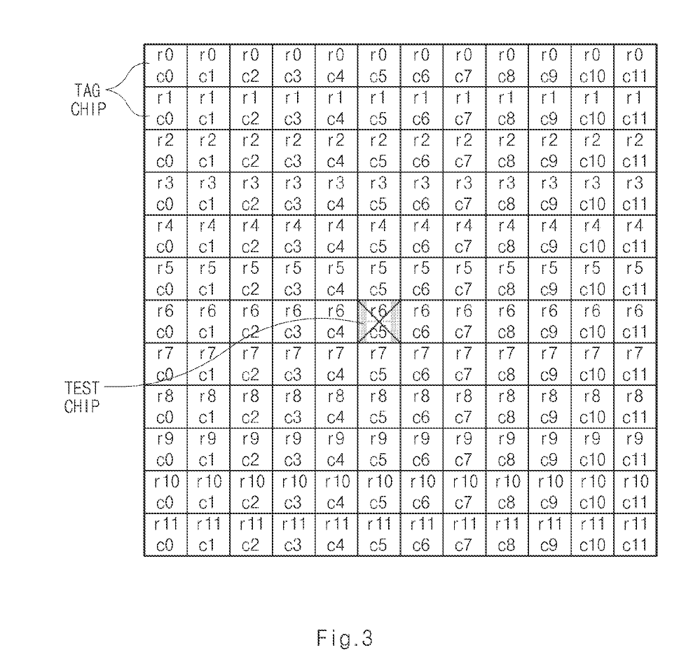

FIG. 3 illustrates alignment of a test chip and tag chips on a wafer according to an embodiment of the present invention.

In accordance with an embodiment of the present invention, a plurality of tag chips are arranged on the wafer in rows and columns, which forms a tag chip array. Each tag chip array includes a plurality of tag chips. That is, the tag chip array means the assembly of RFID tag chips coupled to each other using a scribe lane.

One tag chip array includes one test chip and a plurality of tag chips. One test chip is disposed in the center of the tag chip array. The one test chip tests all tag chips aligned in the corresponding tag chip array.

The “RFID device” in this embodiment includes a test chip and a plurality of tag chips at a wafer level.

The tag chip array according to this embodiment includes one test chip and a plurality of tag chips.

In this embodiment, the tag chips and the test chip exchange input and output signals which represent test commands and test results, respectively, through a scribe lane region formed between the tag chips. That is, the test chip and the plurality of tag chips are coupled to each other by a plurality of scribe lanes arranged in the rows and columns, i.e., X and Y directions.

As a result, the power voltage VDD, the ground voltage GND, the control signals, the addresses and the data which are supplied from the outside are provided to internal circuits of the tag chip through input and output pads of the tag chip via the plurality of scribe lanes arranged in the X and Y directions.

The test output signal TXO and the test result signal XDO generated from the tag chip are also output to the outside via the plurality of scribe lanes arranged in the X and Y directions through the corresponding input and output pads from the internal circuits of the tag chip.

In order to test the tag chip array, the test chip should be initialized. There are various methods of initializing the test chip. For example, when the power voltage VDD is supplied to the RFID device through the power voltage receiving pad, the test chip can be set to be initialized.

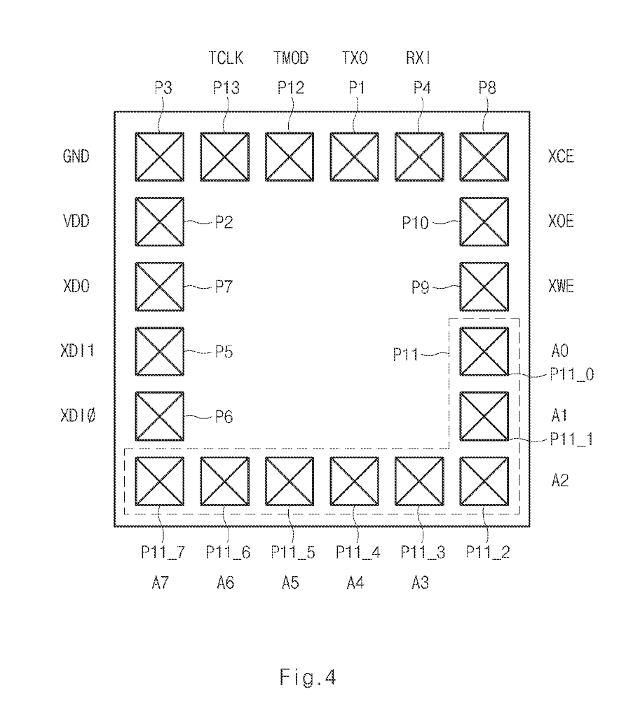

FIG. 4 illustrates the pad configuration of a test chip according to an embodiment of the present invention.

The test chip includes the pads P5 and P6 for receiving the input data XDI1 and XDI0. Also, the test chip includes the test signal output pad P1 for outputting the test output signal TXO to the outside, the power voltage applying pad P2 for receiving the power voltage VDD and the ground voltage applying pad P3 for receiving the ground voltage GND.

The test chip includes the test signal input pad P4 for receiving the test input signal RXI, the data output pad P7 for outputting the output data XDO which is the test result signal, the pad P8 for receiving the chip enable signal XCE, the pad P9 for receiving the write enable signal XWE, and the pad P10 for receiving the output enable signal XOE.

The test chip includes the test input pad P12 for receiving the test mode signal TMOD, the test clock input pad P13 for receiving the test clock TCLK, and the address input pad P11 for receiving the addresses A0˜A7. The address input pad P11 includes a plurality of pads P11_0˜P11_7 for receiving the addresses A0˜A7.

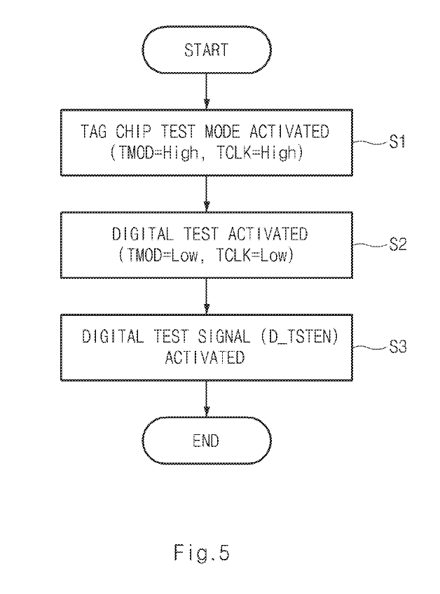

FIG. 5 is a flowchart illustrating a test activating operation for the digital unit 200 in the RFID device according to an embodiment of the present invention.

When the test mode signal TMOD is input at a high level through the test input pad P12, the test clock TCLK is input at a high level through the test clock input pad P13, and the test mode of the tag chip is activated at step S1.

When the test mode signal TMOD (input through the test input pad P12) goes to a low level, and the test clock TCLK (input through the test clock input pad P13) goes to a low level, the test mode for testing the digital unit 200 is activated at step S2.

The test control unit 500 activates the digital test signal D_TSTEN for testing the digital unit 200 in the RFID tag and outputs the activated digital test signal D_TSTEN to the test input buffer 160.

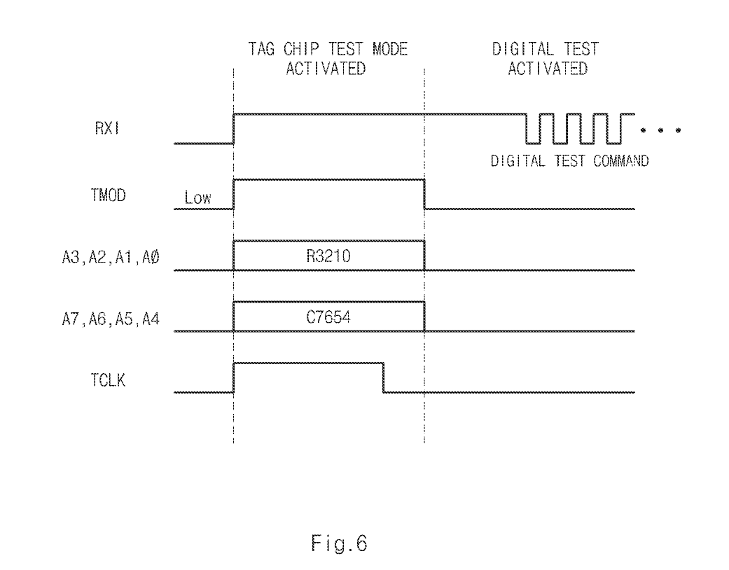

FIG. 6 is a timing diagram illustrating the test activating operation for the digital unit 200 in the RFID device according to an embodiment of the present invention.

When the test mode signal TMOD and the test clock TCLK go to the high level in activation of the test input signal RXI, the test mode of the tag chip is activated.

During a test mode activation period of the tag chip, the addresses A0˜A3 are applied through the pads P11_0˜P11_3, and the addresses A4˜A7 are applied through the pads P11_4˜P11_7. The addresses A0˜A3 represent row addresses R0˜R3, and the addresses A4˜A7 represent column addresses C4˜C7.

Then, when the test mode signal TMOD and the test clock TCLK go to the low level, the test mode for testing the digital unit 200 is activated.

The test control unit 500 activates the digital test signal D_TSTEN for testing the digital unit 200 and outputs the activated digital test signal D_TSTEN to the test input buffer 160.

Then, the test input signal RXI is applied through the test signal input pad P4. As a result, the command signal CMD for testing the digital unit 200 is supplied from the test input buffer 160 to the digital unit 200.

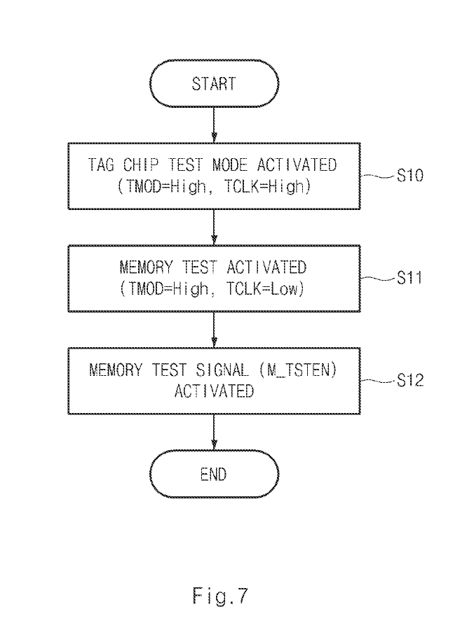

FIG. 7 is a flowchart illustrating a test activating operation for the memory unit 400 in the RFID device according to an embodiment of the present invention.

When the test mode signal TMOD is input at a high level through the test input pad P12, and the test clock TCLK is input at a high level through the test clock input pad P13, the test mode of the tag chip is activated at step S10.

When the test clock TCLK input through the test clock input pad P13 goes to a low level while the test mode signal TMOD input through the test input pad P12 maintains the high level, the test mode for testing the memory unit 400 is activated at step S11.

Then, the test control unit 500 activates the memory test signal M_TSTEN for testing the memory unit 400 and outputs the activated memory test signal M_TSTEN to the test interface unit 300.

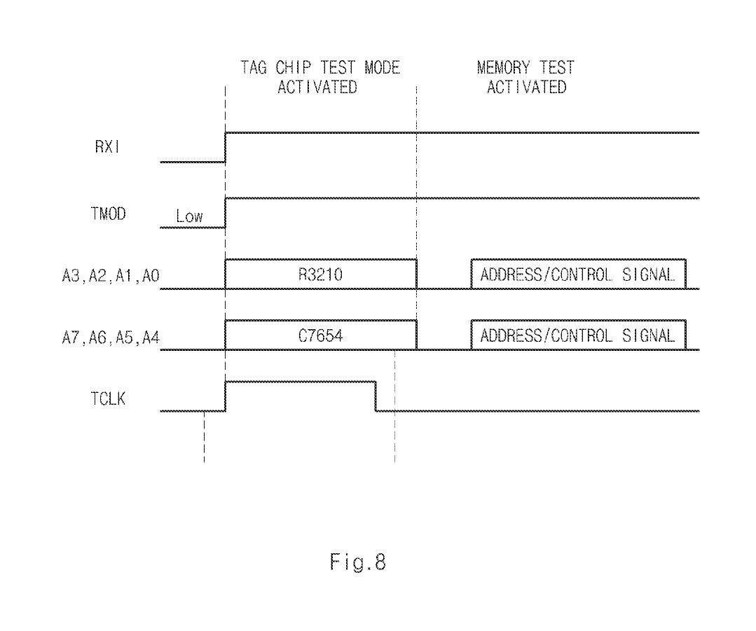

FIG. 8 is a timing diagram illustrating the test activating operation for the memory unit 400 in the RFID device according to the embodiment of the present invention.

When the test mode signal TMOD and the test clock TCLK go to the high level in activation of the test input signal RXI, the test mode of the tag chip is activated.

During the test mode activation period of the tag chip, the addresses A0˜A3 are applied through the pads P11_0˜P11_3, and the addresses A4˜A7 are applied through the pads P11_4˜P11_7. The addresses A0˜A3 represent row addresses R0˜R3, and the addresses A4˜A7 represent column addresses C4˜C7.

When the test mode signal TMOD maintains the high level, and the test clock TCLK goes to the low level, the test mode for testing the memory unit 400 is activated.

The test control unit 500 activates the memory test signal M_TSTEN for testing the memory unit 400 and outputs the activated memory test signal M_TSTEN to the test interface unit 300.

Then, the test interface unit 300 generates the address ADD and the control signals I, CE, WE and OE to test the memory unit 400. The address ADD and control signals (I, CE, WE, OE) are based on the addresses A0˜A7 applied from the address input pad P11, the input data XDI1 and XDI0 input through the pads P5 and P6 and the control signals XCE, XWE and XOI input through the control signal input pads P8˜P10. During this operation, the test input signal RXI is fixed at a high level.

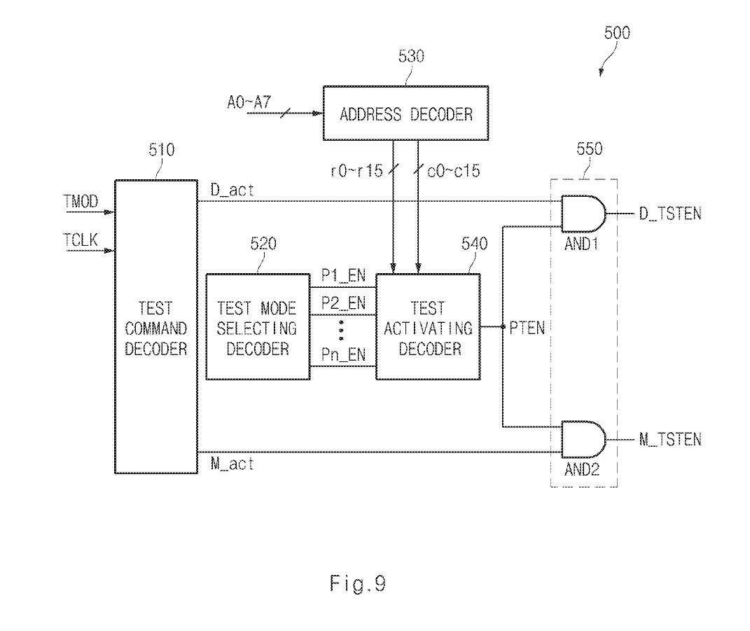

FIG. 9 is a diagram illustrating the test control unit 500 in FIG. 2.

The test control unit 500 includes a test command decoder 510, a test mode selecting decoder 520, an address decoder 530, a test activating decoder 540 and a combination unit 550.

The test command decoder 510 decodes the test mode signal TMOD and the test clock TCLK to activate and output a digital operation signal D_act and a memory operation signal M_act.

The test mode selecting decoder 520 generates a plurality of enable signals P1_EN˜Pn_EN for selecting a parallel test mode and outputs the enable signals P1_EN˜Pn_EN to the test activating decoder 540, where n is a positive integer. The test mode selecting decoder 520 selects tag chips which can be tested simultaneously in response to the plurality of enable signals P1_EN˜Pn_EN.

For instance, the tag chips are tested one by one when the enable signal P1_EN is activated. When the enable signal P2_EN of the plurality of enable signals P1_EN˜Pn_EN is activated, two tag chips are tested simultaneously. When the enable signal Pn_EN of the plurality of enable signals P1_EN˜Pn_EN is activated, n numbers of tag chips are tested simultaneously.

The address decoder 530 decodes the addresses A0˜A7 applied from the address input pad P11 to output a plurality of row addresses r0˜r15 and a plurality of column addresses c0˜c15 to the test activating decoder 540.

The test activating decoder 540 outputs a test enable signal PTEN for activating the corresponding tag chips in response to the plurality of row addresses r0˜r15, the plurality of column addresses c0˜c15 and the plurality of enable signals P1_EN˜Pn_EN.

The combination unit 550 combines the digital operation signal D_act, the memory operation signal M_act and the test enable signal PTEN and outputs the activated digital test signal D_TSTEN or memory test signal M_TSTEN.

The combination unit 550 includes AND gates AND1 and AND2. The AND gate AND1 performs an AND operation on the digital operation signal D_act and the test enable signal PTEN to output the digital test signal D_TSTEN. That is, when both of the digital operation signal D_act and the test enable signal PTEN are activated, the digital test signal D_TSTEN is activated to test the digital unit 200.

The AND gate AND2 performs an AND operation on the memory operation signal M_act and the test enable signal PTEN to output the memory test signal M_TSTEN. That is, when both of the memory operation signals M_act and the test enable signal PTEN are activated, the memory test signal M_TSTEN is activated to test the memory unit 400.

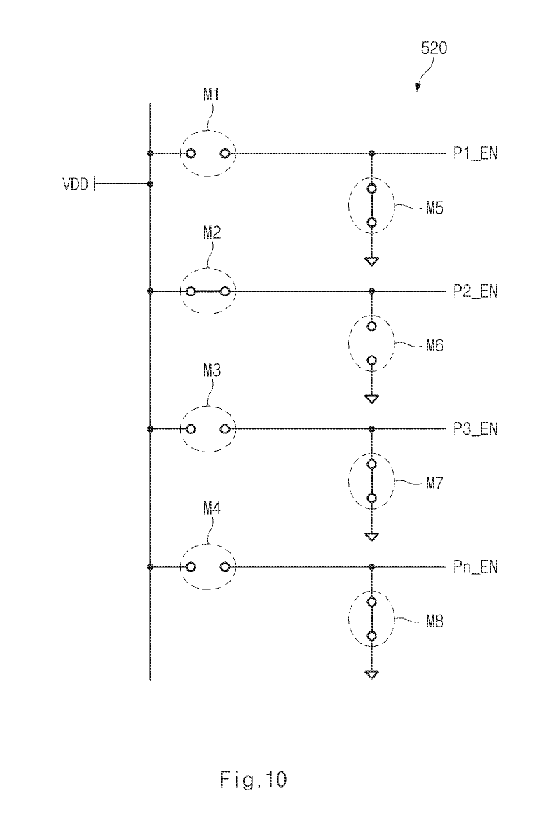

FIG. 10 is a circuit diagram illustrating the test mode selecting decoder 520 in FIG. 9.

The test mode selecting decoder 520 includes a plurality of metal options M1˜M8. The metal options M1˜M4 are coupled between a terminal for receiving the power voltage VDD and output terminals of the plurality of enable signals P1_EN˜Pn_EN. The metal options M5˜M8 are coupled between a ground voltage terminal and the output terminals of the plurality of enable signals P1_EN˜Pn_EN.

The test mode selecting decoder 520 selectively controls the activation of the plurality of enable signals P1_EN˜Pn_EN depending on the connection of the plurality of metal options M1˜M8.

FIG. 10 shows an example when the enable signal P2_EN of the plurality of enable signals P1_EN˜Pn_EN is activated. That is, the metal option M2 of the plurality of metal options M1˜M4 is in a coupled state, and the metal option M6 of the plurality of metal options M5˜M8 is at an open state.

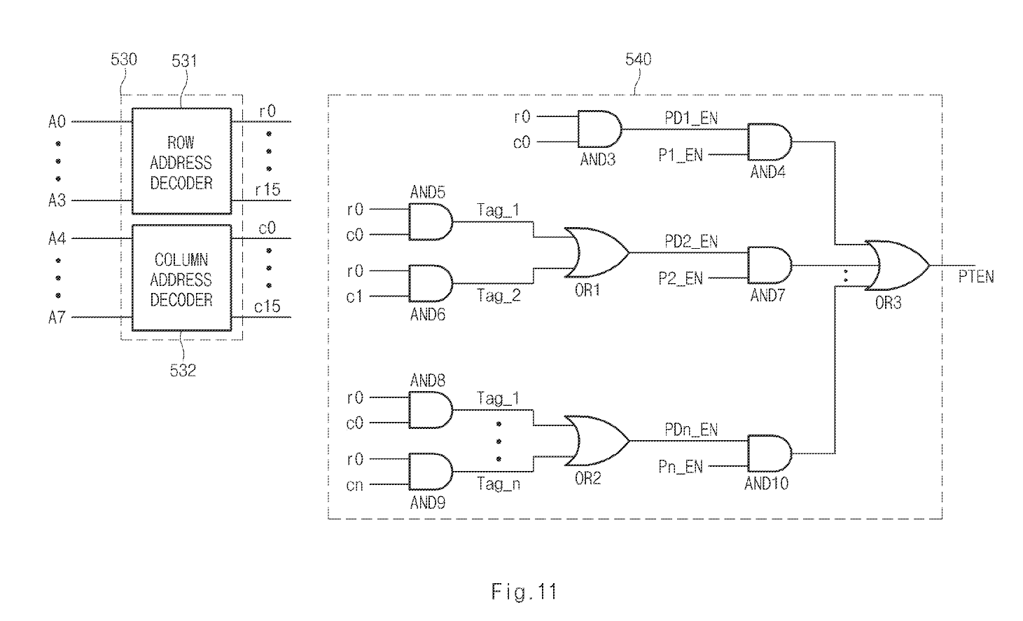

FIG. 11 is a circuit diagram illustrating the address decoder 530 and the test activating decoder 540 in FIG. 9.

The address decoder 530 includes a row address decoder 531 and a column address decoder 532.

The row address decoder 531 decodes the addresses A0˜A3 to output the row addresses r0˜r15 to the test activating decoder 540. The column address decoder 532 decodes the addresses A4˜A7 to output the column addresses c0˜c15 to the test activating decoder 540.

The row addresses r0˜r15 and the column addresses c0˜c15 are addresses for selecting the tag chip where the test operation is performed in the tag chip array. The address decoders of the tag chips corresponding to each parallel test number in the tag chip array are logically AND-coupled to each test activating decoder 540.

The test activating decoder 540 includes a plurality of AND gates, e.g., AND3˜AND10, and a plurality of OR gates, e.g., OR1˜OR3.

The AND gate AND3 performs an AND operation on the row address r0 and the column address c0 to output an enable signal PD1_EN. The AND gate AND4 performs an AND operation on the enable signals PD1_EN and P1_EN.

The AND gate AND5 performs an AND operation on the row address r0 and the column address c0 to output a tag selecting signal Tag_1. The AND gate AND6 performs an AND operation on the row address r0 and the column address c1 to output a tag selecting signal Tag_2. The OR gate OR1 performs an OR operation on the tag selecting signals Tag_1 and Tag_2 to output an enable signal PD2_EN. The AND gate AND7 performs an AND operation on the enable signals PD2_EN and P2_EN.

The AND gate AND8 performs an AND operation on the row address r0 and the column address c0 to output the tag selecting signal Tag_1. The AND gate AND9 performs an AND operation on the row address r0 and the column address cn to output a tag selecting signal Tag_n. The OR gate OR2 performs an OR operation on a plurality of tag selecting signals Tag_1 to Tag_n to output an enable signal PDn_EN. The AND gate AND10 performs an AND operation on the enable signals PDn_EN and Pn_EN.

The OR gate OR3 performs an OR operation on the output signals of the AND gates (e.g., AND4, AND7 and AND10) to output a test enable signal PTEN.

When one tag chip is selected by the row address r0 and the column address c0, the enable signals PD1_EN and P1_EN are activated in the test activating decoder 540.

When two tag chips are selected by the row address r0 and the column address c0, and the row address r0 and the column address c1, the enable signals PD2_EN and P2_EN are activated in the test activating decoder 540.

In this case, while the enable signal P2_EN output from the test mode selecting decoder 520 is activated, any one of the tag selecting signals Tag_1 and Tag_2 is activated. As a result, the enable signal PD2_EN, which is an address decoding signal of the tag chips, is activated.

That is, the two tag chips are activated when one of the column addresses c0 and c1 is activated. As a result, two tag chips can be tested at a time when one of two corresponding column addresses, e.g., c0 and c1, is selected.

When a plurality of tag chips are selected by the row address r0 and the column addresses c0 to cn, the enable signals PDn_EN and Pn_EN are activated in the test activating decoder 540.

Table 1 shows addresses for selecting the tag chips.

TABLE 1

| | | | |
|---|---|---|---|
| Row address | A0 | r0 | LSB |
| | A1 | r1 | |
| | A2 | r2 | |
| | A3 | r3 | MSB |
| Column address | A4 | c4 | LSB |
| | A5 | c5 | |
| | A6 | c6 | |
| | A7 | c7 | MSB |

In Table 1, the addresses A0˜A3 input through the pads P11_0˜P11_3 during the test mode activation period of the tag chip correspond to the row addresses r0˜r3 for selecting a row line of the arrangement of the tag chips. During the test mode activation period of the tag chip, the addresses A4˜A7 input through the pads P11_4˜P11_7 correspond to the column addresses c4˜c7 for selecting a column line of the arrangement of the tag chips.

The address A0 corresponds to the least significant bit of the row addresses, and the address A3 corresponds to the most significant bit of the row addresses. The address A4 corresponds to the least significant bit of the column addresses, and the address A7 corresponds to the most significant bit of the column addresses.

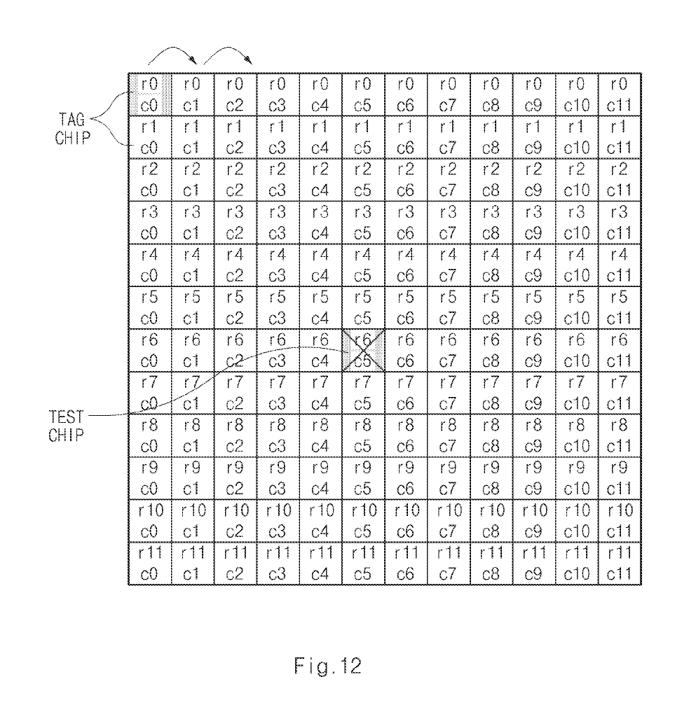

FIGS. 12 to 15 are diagrams illustrating the parallel test method for tag chips depending on activation of the plurality of enable signals P1_EN˜Pn_EN.

FIG. 12 shows when the enable signal P1_EN of the plurality of enable signals P1_EN˜Pn_EN is activated. When the enable signal P1_EN is activated, one tag chip is selected and tested in response to the row address r0 and the column address c0. The test is performed on the tag chips one by one in a direction shown by the arrows.

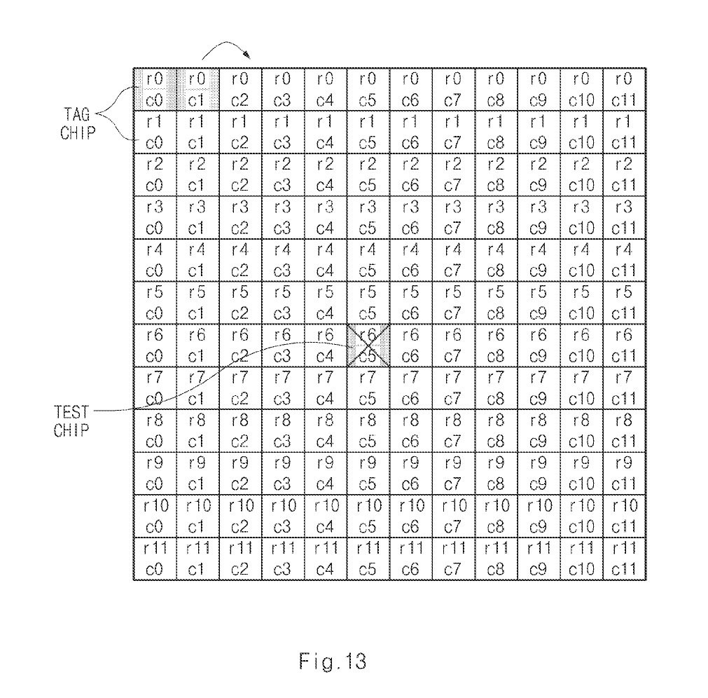

FIG. 13 shows when the enable signal P2_EN of the plurality of enable signals P1_EN˜Pn_EN is activated. When the enable signal P2_EN is activated, two adjacent tag chips are selected and tested in parallel in response to the row address r0 and the column address c0, and the row address r0 and the column address c1. The test is performed on every two tag chips in a direction shown by the arrows.

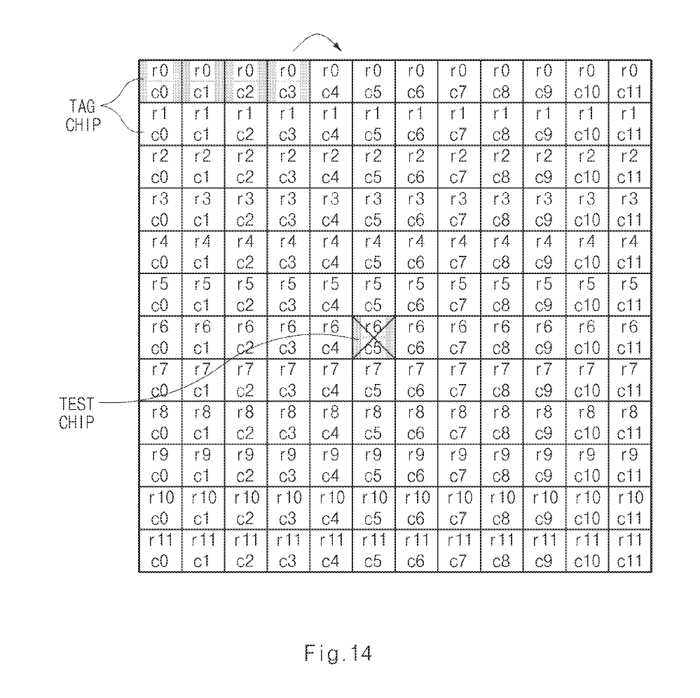

FIG. 14 shows when the enable signal P4_EN of the plurality of enable signals P1_EN˜Pn_EN is activated. When the enable signal P4_EN is activated, four adjacent tag chips are selected and tested in parallel in response to the row address r0 and the column address c0, the row address r0 and the column address c1, the row address r0 and the column address c2, and the row address r0 and the column address c3. The test is performed on every four tag chips in a direction shown by the arrow.

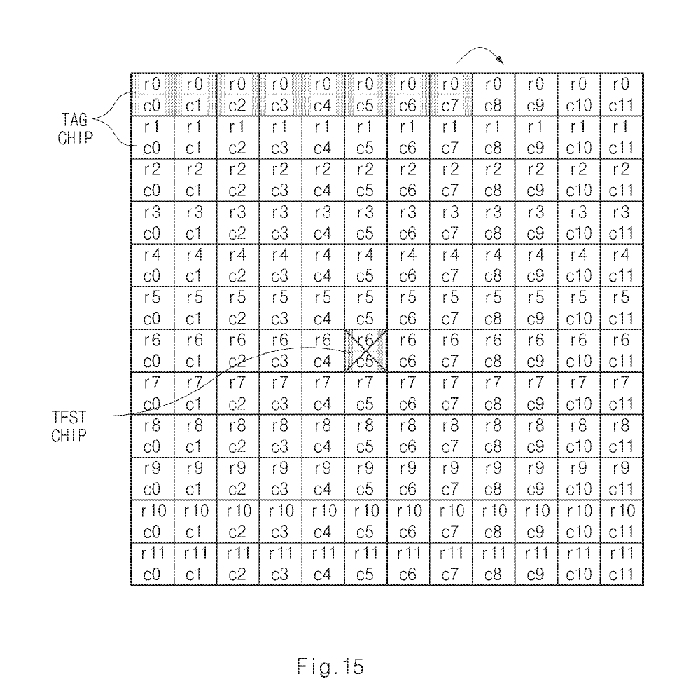

FIG. 15 shows when the enable signal P8_EN of the plurality of enable signals P1_EN˜Pn_EN is activated. When the enable signal P8_EN is activated, eight adjacent tag chips are selected and tested in parallel in response to the row address r0 and the column addresses c0˜c7. The test is performed on every eight tag chips in a direction shown by the arrow.

As described above, the RFID device according to the embodiments of the present invention tests the performance of an RFID tag chip by applying a measuring signal directly through a test pad at a wafer level without using an RF signal applied from an antenna. Also, the RFID device tests each tag chip using a parallel test mode so as to reduce a test time and improve a test speed, thereby reducing the test related costs.

The above embodiments of the present invention are illustrative and not limitative. Various alternatives and equivalents are possible. The invention is not limited by the type of deposition, etching polishing, and patterning steps describe herein. Nor is the invention limited to any specific type of semiconductor device. For example, the present invention may be implemented in a dynamic random access memory (DRAM) device or non-volatile memory device. Other additions, subtractions, or modifications are obvious in view of the present disclosure and are intended to fall within the scope of the appended claims.

What is claimed is:

1. A radio frequency identification (RFID) device comprising:
a plurality of tag chips each configured to perform a test operation in response to a test input signal applied from an external node and output a test output signal corresponding to a result of the test operation; and
a test chip configured to perform a parallel test on the plurality of tag chips in response to a control signal applied from an external node in a test mode.

2. The RFID device according to claim 1, wherein the plurality of tag chips are arranged in column and row directions to form a chip array, the test chip being provided in the chip array and being configured to control the test operation.

3. The RFID device according to claim 1, wherein the plurality of tag chips and the test chip are coupled to each other through a scribe region.

4. The RFID device according to claim 2, wherein the test chip is disposed in the center of the chip array.

5. The RFID device according to claim 1, wherein each of the plurality of tag chips includes a memory unit, the memory unit including a non-volatile ferroelectric device.

6. The RFID device according to claim 1, wherein the test chip receives data and an address from the external node to perform the parallel test on the plurality of tag chips, wherein the test chip includes:
a test signal output pad configured to output the test output signal to an external node;
a power voltage receiving pad configured to receive a power voltage;
a ground voltage receiving pad configured to receive a ground voltage; and
a test signal input pad configured to receive the test input signal.

7. The RFID device according to claim 1, wherein the test chip includes:
a first pad configured to receive the data from an external node;
a data output pad configured to output a test result of a memory unit in the tag chip to an external node;
a second pad configured to receive a chip enable signal from an external node;
a third pad configured to receive a write enable signal from an external node; and
a fourth pad configured to receive an output enable signal from an external node.

8. The RFID device according to claim 1, wherein the test chip includes:
a test clock input pad configured to receive a test clock for controlling the test operation;
a test input pad configured to receive a test mode signal for activating the test mode of the tag chip; and
an address input pad configured to receive a plurality of addresses for selecting tag chips which are tested in parallel among the plurality of tag chips.

9. An RFID device comprising:
an analog unit configured to output a command signal in response to a test input signal applied from the outside and output a test output signal corresponding to a response signal to the outside in a test mode;
a digital unit configured to output the response signal to the analog unit and output operation control signals in response to the command signal;
a memory unit configured to read out or write data in a cell array in response to an internal control signal;
a test interface unit configured to generate the internal control signal in response to data and a control signal applied from the outside, perform a test operation on the memory unit, and output a result of the test operation to the outside; and
a test control unit configured to control activation of the analog unit and the test interface unit in response to a test mode signal, a test clock and an address applied from the outside.

10. The RFID device according to claim 9, wherein, in response to the test mode signal, the test clock and the address, the test control unit outputs a digital test signal to the analog unit or a memory test signal to the test interface unit.

11. The RFID device according to claim 10, wherein the digital test signal is a signal to test the digital unit and the memory test signal is a signal to test the memory unit.

12. The RFID device according to claim 10, wherein the test control unit receives the address in activation of the test mode when the test mode signal and the test clock are at a high level.

13. The RFID device according to claim 10, wherein the test control unit activates the digital test signal when the test mode signal and the test clock are at a low level.

14. The RFID device according to claim 10, wherein the test control unit activates the memory test signal when the test mode signal and the test clock are at a high level and a low level, respectively.

15. The RFID device according to claim 9, wherein the test control unit includes:
a test command decoder configured to decode the test mode signal and the test clock to activate and output a digital operation signal or a memory operation signal, or both;
a test mode selecting decoder configured to output a plurality of enable signals for selecting a parallel test mode;
an address decoder configured to decode the address to output a plurality of row addresses and a plurality of column addresses;
a test activating decoder configured to decode the plurality of row addresses and the plurality of column addresses in response to the plurality of enable signals to output a test enable signal; and
a combination unit configured to combine the test enable signal, the digital operation signal and the memory operation signal to output a digital test signal and a memory test signal.

16. The RFID device according to claim 15, wherein the test mode selecting decoder includes a plurality of metal options to control the plurality of enable signals.

17. The RFID device according to claim 15, wherein the address decoder includes:
a row address decoder configured to decode the address to output the plurality of row addresses; and
a column address decoder configured to decode the address to output the plurality of column addresses.

18. The RFID device according to claim 17, wherein the plurality of row addresses correspond to row addresses used for selecting a row line in alignment of a plurality of tag chips, and the plurality of column addresses correspond to column addresses used for selecting a column line in alignment of the plurality of tag chips.

19. The RFID device according to claim 15, wherein the test mode selecting decoder is configured to output the plurality of enable signals to determine a number of tag chips to be tested in parallel.

20. The RFID device according to claim 9, wherein the test control unit includes:
a test input pad configured to receive the test mode signal;
a test clock input pad configured to receive the test clock; and
an address input pad configured to receive the address.

21. The RFID device according to claim 9, wherein the analog unit includes:
a test signal input pad configured to receive the test input signal;
a test signal output pad configured to output the test output signal to the outside;
a power voltage receiving pad configured to receive a power voltage; and
a ground voltage receiving pad configured to receive a ground voltage.

22. The RFID device according to claim 9, wherein the test interface unit includes:
a first pad configured to receive the data from the outside;
a data output pad configured to output a test result of the memory unit to the outside;
a second pad configured to receive a chip enable signal from the outside;
a third pad configured to receive a write enable signal from the outside; and
a fourth pad configured to receive an output enable signal from the outside.

23. The RFID device according to claim 9, wherein the memory unit includes a non-volatile ferroelectric memory.
